(19) United States
(12) Patent Application Publication
(10) Pub. No.: US 2009/0128896 A1
(43) Pub. Date: May 21, 2009

(54) CATADIOPTRIC PROJECTION OBJECTIVE WITH INTERMEDIATE IMAGE

(75) Inventor: Aurelian Dodoc, Oberkochen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG,, Oberkochen (DE)

(21) Appl. No.: 11/815,522

(22) PCT Filed: Jan. 28, 2006
(86) PCT No.: PCT/EP06/00740

§ 371 Date: Apr. 28, 2008

Related U.S. Application Data
(60) Provisional application No. 60/649,140, filed on Feb. 3, 2005.

(51) Int. Cl. G02B 17/08

(52) U.S. Cl. 359/364

(57) ABSTRACT

In a catadioptric projection objective for imaging a pattern of a mask arranged in an object surface (as) of the projection objective into an image field arranged in the image surface (IS) of the projection objective, with a demagnifying imaging scale, having at least one concave mirror (CM) and at least one intermediate image, the object plane and the image plane are originated parallel to one another. A deflection system (DS) for deflecting bundles of rays from one part of the projection objective into another part of the projection objective is arranged between the object plane and the image plane. The deflection system contains an image rotating reflection device which is designed to effect an image rotation through 180° by multiple reflection at planar reflection surfaces situated at an angle with respect to one anther, whereby the imaging scale has the same sign in two planes perpendicular to an optical axis and perpendicular to one another.

### BACKGROUND OF THE INVENTION

1. Field of the Invention

The invention relates to a catadioptric projection objective having at least one concave mirror and at least one intermediate image. A preferred field of application is projection objectives for microlithography which serve for imaging a pattern of a mask arranged in an object surface of the projection objective into an image field arranged in the image surface of the projection objective, with a demagnifying imaging scale.

2. Description of the Related Prior Art

Catadioptric projection objectives of the R-C-R type have been known for many years. Such an imaging system comprises three cascaded (or concatenated) imaging subsystems, that is to say has two intermediate images. A first, refractive subsystem (abbreviation “R”) generates a first real intermediate image of an object. A second, catadioptric or catoptric subsystem (abbreviation “C”) with a concave mirror generates a real second intermediate image from the first intermediate image. A third, refractive subsystem images the second intermediate image into the image plane. The deflection of the beam path between these three subsystems is generally ensured by a deflection system having two plane mirrors oriented at a right angle with respect to one another. Object plane and image plane of the projection objective may thereby be oriented parallel to one another.

Systems of this type have been described under many aspects in the specialist literature. In this respect, see inter alia the patent applications US 2003/0234912, US 2003/0197946, EP 1 191 378 and also the US provisional applications—filed by the applicant—60/530,622 with application date Dec. 19, 2003 or 60/571,533 with application date May 17, 2004. The disclosure of these provisional applications is incorporated by reference in the content of this description.

All these systems and system variants have a disadvantage: although the imaging scale of the system has the same value in two preferred planes perpendicular to one another, it nonetheless has different signs. This problem is also known as “image flip”.

Refractive projection objectives and also many conventional catadioptric projection objectives of other types have no “image flip”. Therefore, a conventional R-C-R system cannot readily be used in a projection exposure apparatus which is designed for a refractive projection objective or for a conventional catadioptric projection objective without “image flip”. Rather, conventional R-C-R systems can be used in such an “old” machine only with corresponding adaptation of the mask (reticle). However, this is a cost-intensive task since the customer has to procure new masks which basically carry the same information as the old masks.

Systems of the R-C-R type without “image flip” are also known. In the case of these systems, however, the object plane and the image plane are perpendicular to one another. Scanner operation is thereby made considerably more difficult. Systems of this type are described e.g. in U.S. Pat. No. 5,861,997.

The U.S. Pat. No. 5,159,172 and U.S. Pat. No. 4,171,870 describe intermediate-image-free projection systems of the Dyson type which have no “image flip”. A roof prism is used here within the projection system.

### SUMMARY OF THE INVENTION

One object of the invention is to provide catadioptric projection objectives of the R-C-R type which are suitable for use in wafer scanners and which make it possible to use masks which can also be used with refractive projection objectives or catadioptric projection objectives without “image flip”.

These and other objects are achieved, in accordance with one aspect of the invention, by means of a catadioptric projection objective for lithography having an odd number of plane mirrors and an odd number of concave mirrors and at least one intermediate image.

In accordance with another formulation of the invention, the object is achieved by means of a catadioptric projection objective for lithography having an even number of plane mirrors and an even number of concave mirrors and at least one intermediate image.

In accordance with a further formulation of the invention, the object is achieved by means of a catadioptric projection objective for lithography formed from a first subsystem, which forms a first intermediate image, a second subsystem, which forms a second intermediate image, and comprises a concave mirror near the pupil, and a third subsystem, which images the second intermediate image onto the image plane, wherein an even number of mirrors is arranged in between the object plane and the concave mirror and an odd number of mirrors is arranged in between the concave mirror and the image plane.

In accordance with a further formulation of the invention, the object is achieved by means of a projection objective for lithography formed from a first subsystem, which forms a first intermediate image, a second subsystem, which forms a second intermediate image, and comprises a concave mirror near the pupil, and a third subsystem, which images the second intermediate image onto the image plane, wherein an odd number of mirrors is arranged in between the object plane and the concave mirror and an even number of mirrors is arranged in between the concave mirror and the image plane.

Advantageous developments are specified in the dependent claims. The wording of all the claims is incorporated by reference in the content of the description.

When utilizing concave mirrors within a projection objective, it is necessary to use beam deflection devices if obscuration-free and vignetting-free imaging is to be achieved. Systems with geometric beam splitting, e.g. by means of one or a plurality of fully reflective folding mirrors (deflection mirrors), and also systems with physical beam splitting are known. Moreover, it is possible to use plane mirrors for folding the beam path. These are generally used in order to fulfill specific structural space requirements or in order to orient object plane and image plane parallel to one another.

An arrangement of reflective surfaces that deflect bundles of rays from one part of the projection objective into another part is referred to hereinafter as “deflection system”.

In preferred embodiments, the deflection system comprises an image rotating reflection device, which is designed to effect an image rotation through 180°, that is to say a complete erection of an image, by multiple reflection at planar reflection surfaces situated at an angle with respect to one another. This can be realized in compact form by roof-type design of reflecting surfaces. In one variant, a reflection prism (reflecting prism) is used for this purpose. The reflecting prism may be configured as a roof prism and contain a roof-type arrangement of planar reflecting surfaces. Reflection prisms in the manner of pentaprisms can also be used. In other embodiments, the image rotating reflection device is embodied as a pure mirror system in the manner of an angular mirror.

The above and further features emerge not only from the claims but also from the description and from the drawings, in which case the individual features may be realized, and may represent embodiments which are advantageous and which are protectable per se, in each case on their own or as a plurality in the form of sub-combinations in embodiments of the invention and in other fields.

### BRIEF DESCRIPTION OF THE DRAWINGS

FIG. 1 schematically shows a reference system of the R-C-R type with image flip;

FIG. 2 shows different embodiments of image rotating reflection devices, a roof prism being illustrated in (a) and an angular mirror being illustrated in (b);

FIG. 3 shows an embodiment of an R-C-R system with a roof prism in the pupil space of the first, refractive subsystem;

FIG. 4 shows an embodiment of an R-C-R system with a roof prism in the vicinity of the first intermediate image;

FIG. 5 shows an embodiment of an R-C-R system with a roof prism between the second and third subsystems;

FIG. 6 shows different embodiments of deflection systems in which a planar reflecting surface is formed by a reflecting inner surface of a prism;

FIG. 7 shows an embodiment of an R-C-R system in which the beam path leading to the concave mirror and the beam path leading away from the concave mirror cross in the region of the deflection system;

FIG. 8 shows a variant of the system in FIG. 7 in which the reflecting surfaces of the deflection system are further away from the second intermediate image;

FIG. 9 shows different variants of a deflection system with crossed and uncrossed beam path;

FIG. 10 shows exemplary embodiments of deflection systems with a physical beam splitter having a planar, polarization-selective reflection layer in combination with a plane mirror (a) and with a concave mirror (b);

FIG. 11 shows an embodiment of an R-C-R system with a deflection system having a physical beam splitter in the pupil space of the first subsystem;

FIG. 12 shows an embodiment of an R-C-R system with a centered object field, the deflection system having a physical beam splitter;

FIG. 13 shows an embodiment of an R-C-R system in which the deflection system comprises a physical beam splitter having two polarization-selective beam splitter layers that are offset parallel to one another;

FIG. 14 shows an embodiment of an R-C-R system in which the deflection system has a physical beam splitter and a plane mirror arranged in the beam path upstream of the beam splitter;

FIG. 15 (a) to (d) show different variants of deflection systems with a physical beam splitter and a deflection prism in the light path upstream and downstream of the beam splitter;

FIG. 16 shows a lens section through an embodiment of an R-C-R system with a physical beam splitter, the first intermediate image being arranged upstream of the beam splitter and the second intermediate image being arranged between the beam splitter and a plane mirror;

FIG. 17 shows a schematic illustration of the mirrors of a deflection system by means of which the optical axis of the projection objective is folded in two mutually perpendicular planes (three-dimensionally); and

FIG. 18 shows a lens section through a projection objective of the type illustrated in FIG. 17.

### DETAILED DESCRIPTION OF THE PREFERRED EMBODIMENTS

In the following description of preferred embodiments, the term “optical axis” denotes a straight line or a sequence of straight line sections through the centers of curvature of the optical components. The optical axis is folded at folding mirrors (deflection mirrors) or other reflective surfaces. In the examples, the object is a mask (reticle) having the pattern of an integrated circuit; a different pattern, for example of a grating, may also be involved. In the examples, the image is projected onto a wafer that is provided with a photoresist layer and serves as a substrate. Other substrates, for example elements for liquid crystal displays or substrates for optical gratings, are also possible.

The traditional construction of a system of the R-C-R type is illustrated in FIG. 1 on the basis of a reference system REF—not associated with the invention—with “image flip”. In this case, the imaging scale has opposite signs in two planes that are perpendicular to the optical axis OA and perpendicular to one another. The system serves for imaging a pattern arranged in an object plane OS of the projection objective into an image plane IS of the projection objective. It comprises three cascaded imaging subsystems, that is to say has precisely two real intermediate images. It has a first, refractive subsystem formed from a first lens group LG1 and a second lens group LG2, a second, catadioptric subsystem formed from a concave mirror CM, a lens group LG21 near the field and a second lens group LG22, and a third, refractive subsystem formed from two lens groups LG31 and LG32. Situated between the lens groups LG11 and LG12, and respectively between the lens groups LG31 and LG32, is a pupil surface (PS) in which an aperture diaphragm may be used.

The second subsystem may be embodied with or without the first group LG21 near the field (in this respect, see e.g. WO 2004/019128 for systems without a lens group near the field, or the applicant's U.S. provisional application 60/571,533 with application date May 17, 2004 for systems with a lens group near the field. The disclosure of this provisional application is incorporated by reference in the content of this description.)

The deflection of the beam path between these three subsystems is ensured by a deflection system (DS). The latter is realized by means of a prism DS in FIG. 1, said prism's externally mirror-coated cathetus surfaces oriented at right angles to one another serving as reflecting surfaces.

In the following exemplary embodiments, the same reference identifications are used in each case for corresponding components and other features.

The solution approaches realized in the present embodiments essentially relate to the deflection system. In the sense of this invention, “deflection system” should be understood to mean an arrangement of reflective surfaces which guide the bundles of rays from one part of the system to the subsequent part of the system and connect the optical axes of the subsystems to one another, to be precise in particular such that the image plane IS and the object plane OS of the objective run parallel to one another.

The position of the intermediate images relative to the deflection system and to the groups LG12, LG21 and LG31 present can vary. The positioning of the intermediate images in the vicinity of the deflection system is expedient.

The way in which the object is achieved in the embodiments is essentially based on the incorporation of an additional reflective surface in comparison with conventional systems. Where and in what arrangement said surface is incorporated differentiates the solution approaches.

A first solution approach relates to the incorporation of a “roof edge” into the projection objective. The roof edge with a roof-type design of reflecting surfaces is intended to effect an image rotation through 180 degrees and preferably has two planar reflecting surfaces situated at a right angle with respect to one another.

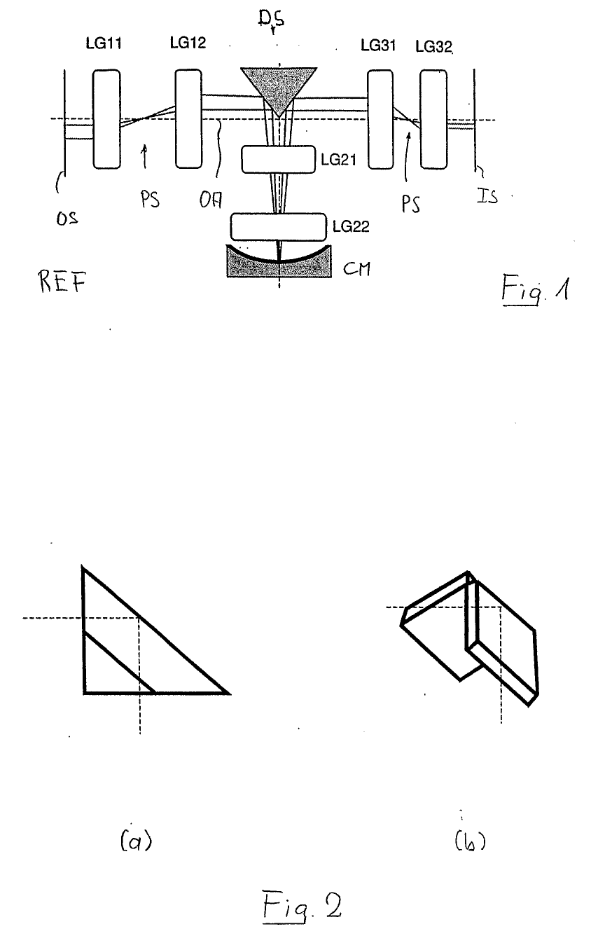

Said “roof edge” may be realized both by means of a half cube prism and by means of two combined reflecting surfaces. Two expedient types of embodiment are illustrated in FIGS. 2(a) and 2(b). In the case of the one-piece variant of a roof-edge deflection prism in (a), the relative arrangement of the reflecting surfaces is stable. Since the relative position of the reflective surfaces plays an important part, this may be advantageous. However, a half cube prism with a roof edge can be produced with the required precision only with a high outlay. Detailed descriptions of deflection prisms of this type are found in the U.S. Pat. No. 5,159,172 and U.S. Pat. No. 4,171,870. The advantage of the construction with two separate plane mirrors (b) is that both mirrors can be adjusted separately (individually).

The roof edge is explained below using the example of a roof prism, but both variants (a) and (b) are to be understood by this.

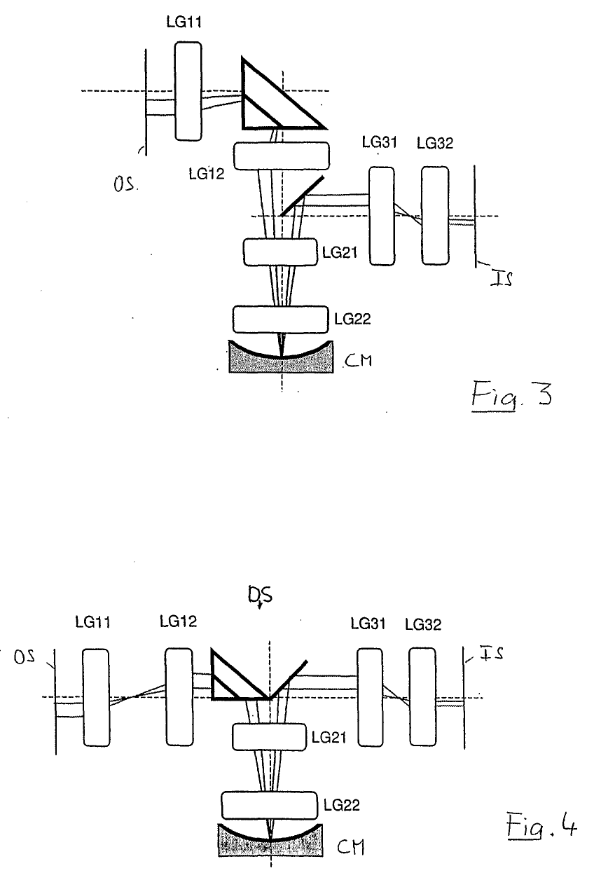

A first expedient position is in the first subsystem. FIG. 3 illustrates such an arrangement in which the roof edge is arranged in the pupil space of the first subsystem.

A second expedient position for a roof edge is the vicinity of the first intermediate image. The latter arises downstream of the first subsystem, that is to say downstream of the group LG12. The roof edge may be inserted between the first and second or between the second and third subsystems. FIG. 4 shows such an arrangement.

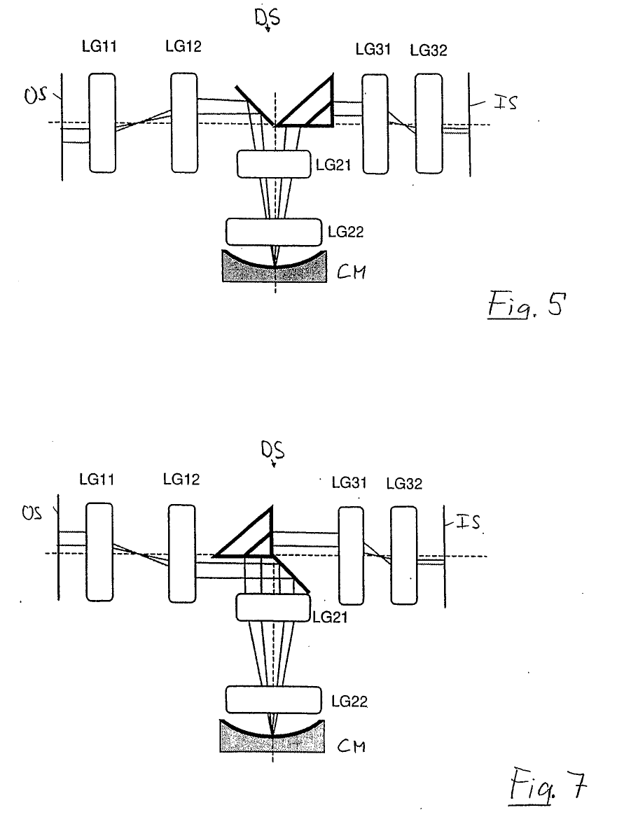

A further expedient position is in the vicinity of the second intermediate image, that is to say between the second and third subsystems. FIG. 5 illustrates this arrangement.

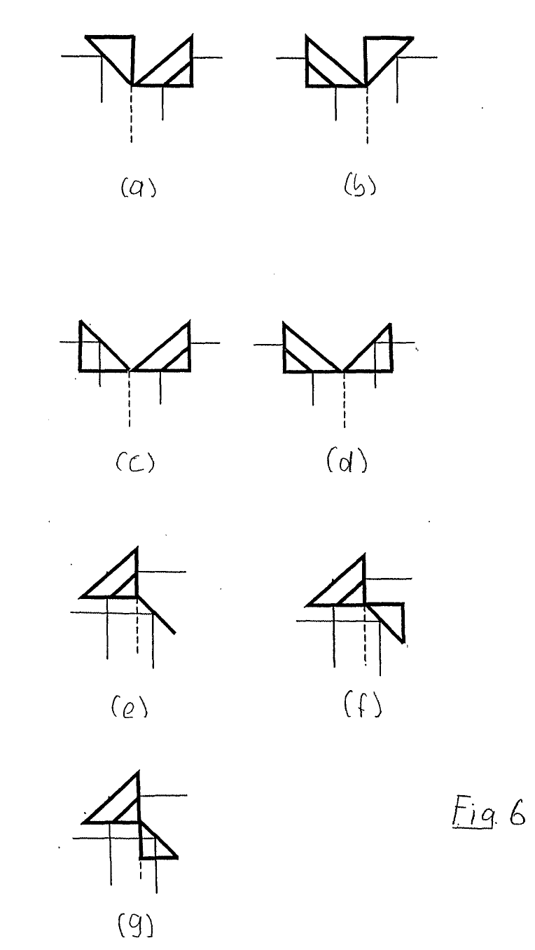

It is also expedient to represent the reflective surface by a prism. Various embodiments of the deflection system are illustrated in FIG. 6.

FIG. 7 illustrates further embodiments. The wider installation space for the deflection system is particularly expedient here.

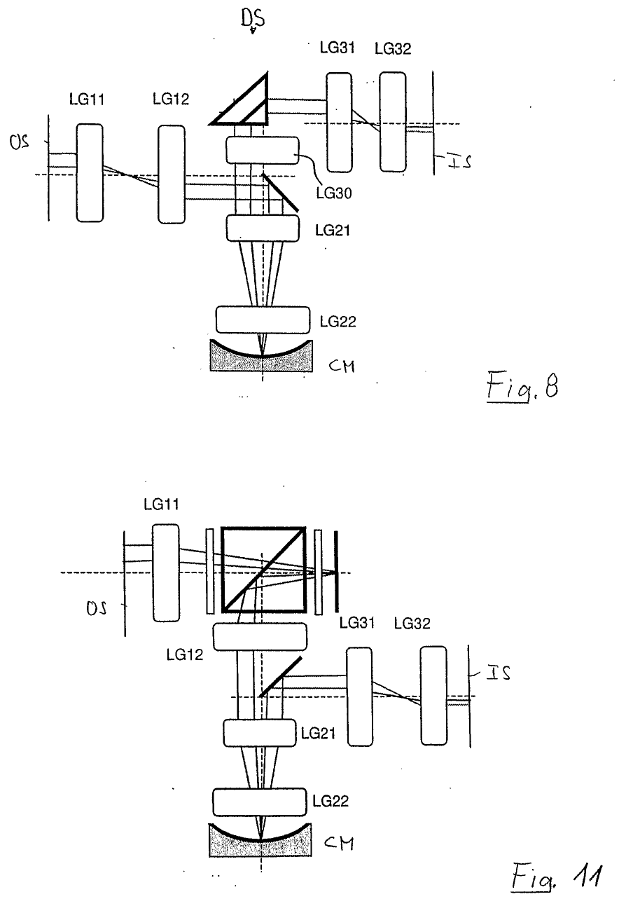

An arrangement in accordance with FIG. 8 is also possible. Here the reflecting surfaces are further away from the second intermediate image.

A second solution approach consists in incorporating a 90° deflection system formed from an even number of successive reflecting surfaces whose normals are parallel. Embodiments of angular mirrors having precisely two plane mirrors are appropriate here. Owing to the use in the divergent beam path, these arrangements can be used well in a manner free of vignetting (or shading) primarily at small apertures.

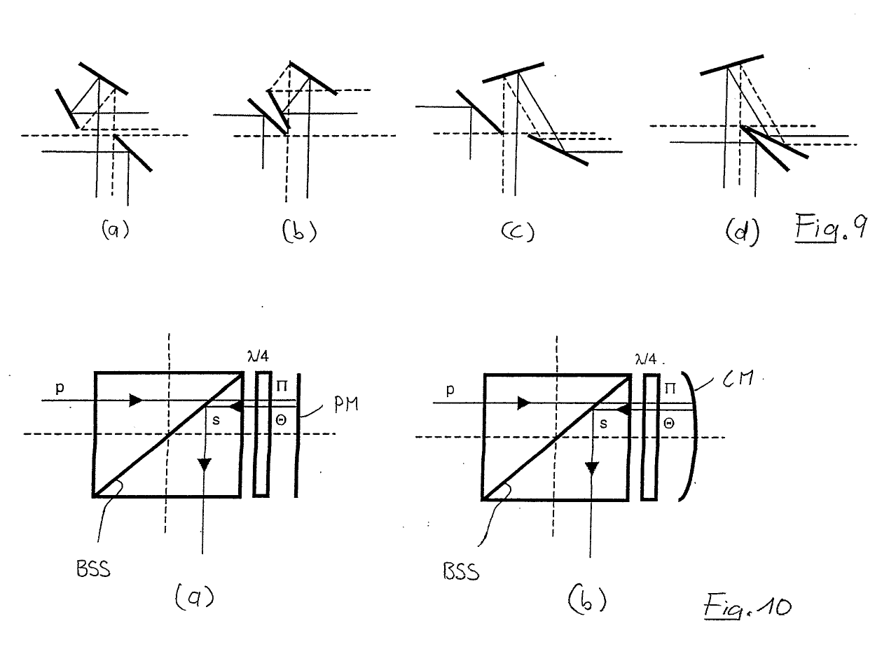

FIGS. 9(a) to (d) show embodiments of the deflection system with a crossed and uncrossed beam path. Some beam guidances are also possible using prisms. By way of example, the beam guidance according to (a) can also be achieved using a pentaprism.

A third solution approach is based on the use of a beam splitter cube with a beam splitter surface (BSS) in combination with a mirror in order to deflect the beam path by 90°.

An exemplary construction is illustrated in FIG. 10, on the one hand with a plane mirror PM and on the other hand with a curved mirror CM. The physical beam splitter has a planar, polarization-selective beam splitter surface BSS. A λ/4 plate is inserted between the beam splitter and the mirror PM or CM. The reflecting surfaces of the mirrors may be aspherized or planar or spherically curved.

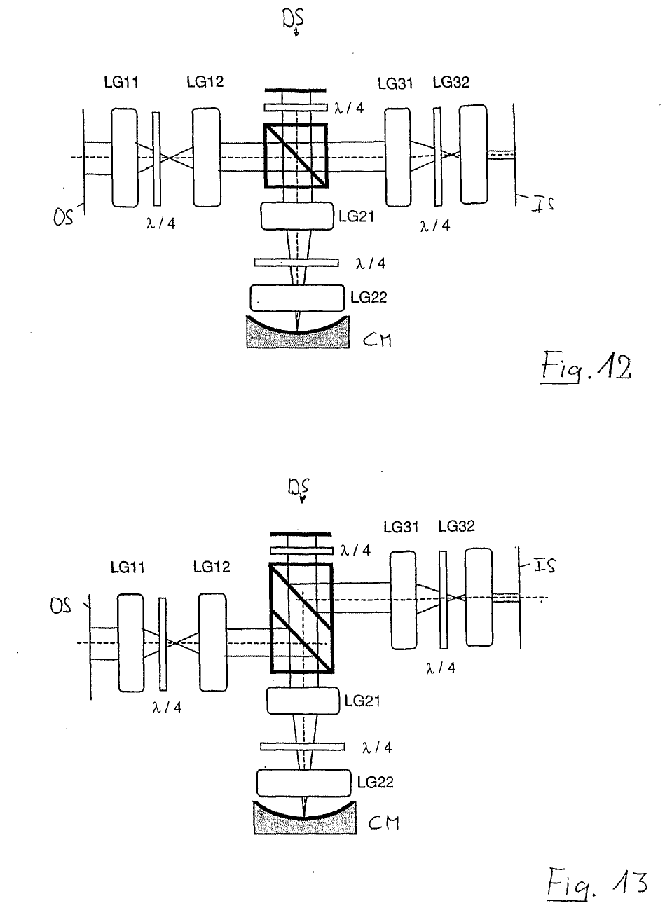

A first preferred location for incorporating said deflection system is in the pupil space of the first subsystem. The construction is illustrated in FIG. 11.

A further preferred incorporation location is in the vicinity of the intermediate images. Two further variants may be differentiated here: with a centered field and with an uncentered field.

In a first embodiment of the first variant, the beam splitter cube is incorporated in such a way that the field of the objective can be positioned in a manner centered with respect to the optical axis. FIG. 12 illustrates a preferred arrangement.

It is expedient to position the first intermediate image upstream of the beam splitter and the second intermediate image between the beam splitter and the plane mirror. FIG. 16 shows an exemplary embodiment.

The specification of the design shown in FIG. 16 is summarized in tabular form in table 1. In this case, column 1 specifies the number of the refractive surface, reflective surface or surface distinguished in some other way, column 2 specifies the radius r of the surface (in mm), column 3 specifies the distance d between the surface and the succeeding surface (in mm), column 4 specifies the material of a component and column 5 specifies the maximum usable semidiameters in mm. The reflective surfaces are indicated in column 6.

In the embodiment, thirteen of the surfaces are aspherical, namely the surfaces 2, 7, 14, 19, 25, 29, 37, 41, 55, 56, 58, 63 and 73. Table 1A specifies the corresponding aspherical data, the sagittae of the aspherical surfaces being calculated according to the following specification:

p(h)=[((1/r)h²)/(1+SQRT(1−(1+K)(1/r)²h²))]+C1*h⁴+C2*h⁶+ . . .

In this case, the reciprocal (1/r) of the radius specifies the surface curvature at the surface vertex and h specifies the distance between a surface point and the optical axis. Consequently, p(h) specifies said sagitta, that is to say the distance between the surface point and the surface vertex in the z direction, that is to say in the direction of the optical axis. The constants K, C1, C2 . . . are reproduced in table 1A.

The immersion objective shown in FIG. 16 is designed for an operating wavelength of approximately 193 nm, at which the synthetic quartz glass (SiO₂) used for most of the lenses (with the exception of the two CaF₂ lenses nearest the image) has a refractive index of n=1.5602. It is adapted to ultrapure water as immersion medium (nᵢ=1.4367 at 193 nm) and has an image-side working distance of 4 mm. The image-side numerical aperture NA is 1,2, the imaging scale is 4:1. The system is designed for an image field with a size of 26×5 mm².

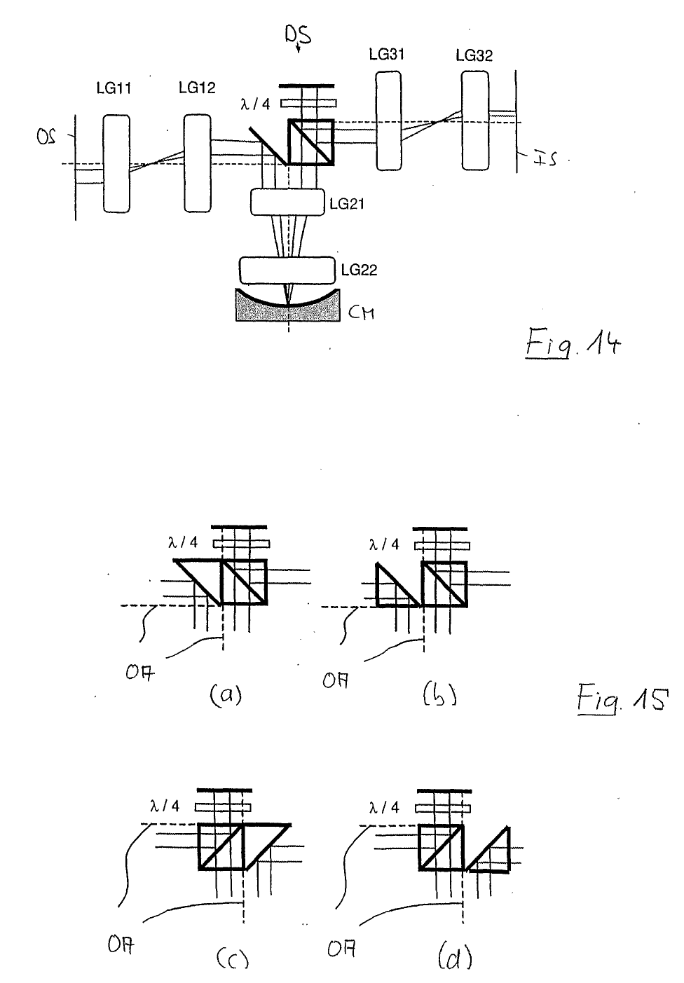

A second embodiment has the advantage that the spurious light can be reduced by means of a second polarization-selective beam splitter surface BSS. Said spurious light essentially comprises light which is transmitted by the beam splitter surface BSS instead of being reflected. A corresponding solution has also been proposed in a different context in the applicant's WO 2004 092801. FIG. 13 illustrates an exemplary construction.

A preferred embodiment of the second variant is illustrated in FIG. 14. Here the beam path between object plane and concave mirror is folded by means of a plane mirror, and the beam splitter with the adjacent plane mirror in accordance with FIG. 10 is used for folding between the concave mirror and the image plane.

The opposite order is also possible.

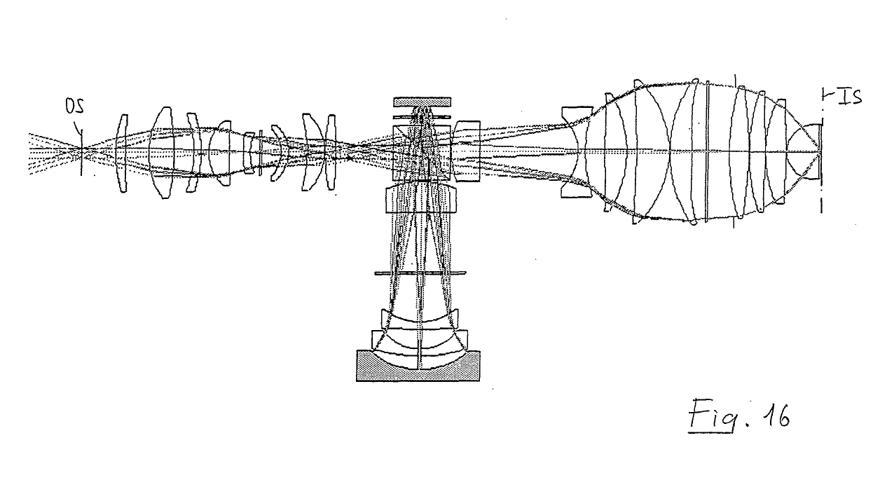

FIG. 14 illustrates this arrangement. Various other constructions of the deflection system with folding of the optical axis OA are shown in FIG. 15.

In another preferred arrangement, the mirror has an aspherical surface. This mirror can thus act on field-dependent aberrations since it is situated directly near the field.

The intermediate image in direct proximity to the mirror may be positioned upstream of the mirror or downstream of the mirror in the beam propagation direction. It is thus possible to decide what subsystem the mirror belongs to.

This principle can be applied to all the design variants of this notification of invention and thus generates classes of systems with two intermediate images which are part of this invention.

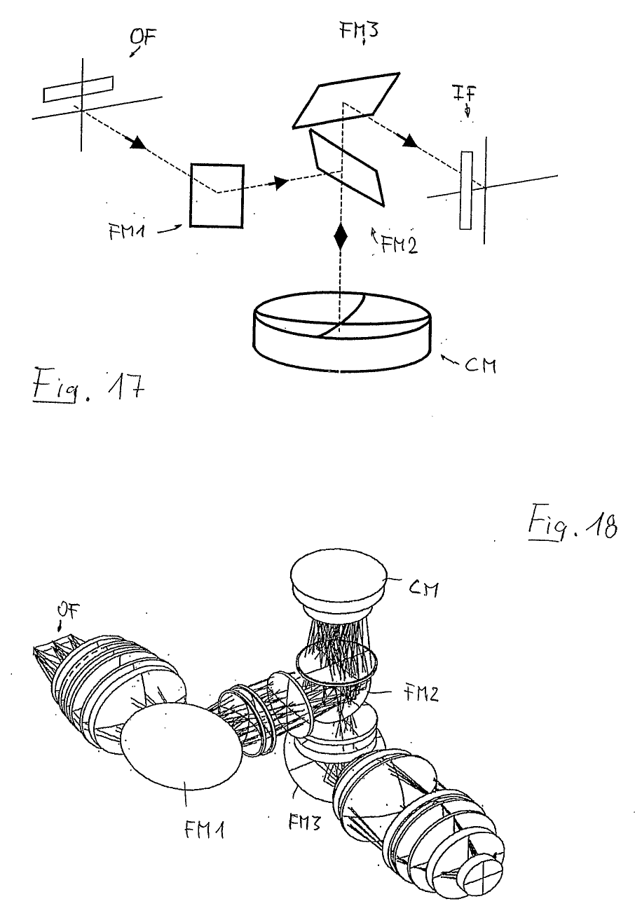

A further variant is for the system to be folded 3-dimensionally. A schematic diagram of this arrangement is illustrated in FIG. 17. Here the object field or object plane OS and image field or image plane IS are perpendicular to one another. A plurality of folding mirrors FM are provided, the folding planes of the folding mirrors FM1 and FM2 and also the folding planes of the folding mirrors FM2 and FM3 in each case being perpendicular to one another. To simplify the illustration, the illustration of the lens groups has been dispensed with in the diagram. A schematic perspective view of such a system with lens groups is illustrated in FIG. 18.

TABLE 1

| SURFACE | RADIUS | DISTANCE | MATERIAL | ½ DIAM. | TYPE |
|---|---|---|---|---|---|
| 0 | 0.000000000 | 40.831379976 | AIR | 52.953 | |
| 1 | 0.000000000 | 24.835799484 | AIR | 65.702 | |
| 2 | 234.630584765 | 19.429927130 | SIO2 | 77.200 | |
| 3 | 882.148666373 | 46.883533441 | AIR | 78.149 | |
| 4 | 168.069962564 | 51.258373323 | SIO2 | 91.413 | |
| 5 | −474.467452503 | 39.922503272 | AIR | 89.565 | |
| 6 | −227.670003620 | 15.029746528 | SIO2 | 78.890 | |
| 7 | −206.868547526 | 14.143757015 | AIR | 78.106 | |
| 8 | 86.948835427 | 41.655013939 | SIO2 | 64.884 | |
| 9 | 537.143522653 | 28.733941903 | AIR | 57.011 | |
| 10 | 207.952018841 | 15.071910871 | SIO2 | 40.526 | |
| 11 | 106.536992025 | 19.355848139 | AIR | 40.905 | |
| 12 | 0.000000000 | 5.000000000 | SIO2 | 44.214 | |
| 13 | 0.000000000 | 38.858864961 | AIR | 45.140 | |
| 14 | −77.054273793 | 14.998448433 | SIO2 | 50.631 | |
| 15 | −78.501918289 | 39.212334529 | AIR | 56.545 | |
| 16 | −257.255659305 | 35.872350986 | SIO2 | 72.013 | |
| 17 | −110.014113342 | 1.212603544 | AIR | 76.470 | |
| 18 | 394.013193318 | 20.991811294 | SIO2 | 74.733 | |
| 19 | −1471.352774030 | 99.079837362 | AIR | 74.057 | |
| 20 | 0.000000000 | 0.000000000 | AIR | 93.422 | |
| 21 | 0.000000000 | 19.988076183 | AIR | 93.422 | |
| 22 | 0.000000000 | 60.000000000 | SIO2 | 97.744 | |
| 23 | 0.000000000 | −60.000000000 | SIO2 | 108.913 | REFL |
| 24 | 0.000000000 | −0.985111420 | AIR | 114.171 | |
| 25 | −178.398872599 | −64.451787326 | SIO2 | 124.254 | |
| 26 | 47144.919255000 | −126.903968181 | AIR | 121.481 | |
| 27 | 0.000000000 | −4.983157099 | SIO2 | 91.630 | |
| 28 | 0.000000000 | −99.278790116 | AIR | 90.894 | |
| 29 | 104.310941407 | −14.990241988 | CAF2 | 73.774 | |
| 30 | 1166.151013050 | −41.319355870 | AIR | 77.281 | |
| 31 | 97.189754599 | −14.997346418 | SIO2 | 77.798 | |
| 32 | 328.968784100 | −28.451179600 | AIR | 96.333 | |
| 33 | 152.464438200 | 28.451179600 | AIR | 99.858 | REFL |
| 34 | 328.968784100 | 14.997346418 | SIO2 | 94.919 | |
| 35 | 97.189754599 | 41.319355870 | AIR | 72.620 | |
| 36 | 1166.151013050 | 14.990241988 | CAF2 | 69.049 | |
| 37 | 104.310941407 | 99.278790116 | AIR | 64.436 | |
| 38 | 0.000000000 | 4.983157099 | SIO2 | 72.147 | |
| 39 | 0.000000000 | 126.903968181 | AIR | 72.460 | |
| 40 | 47144.919255000 | 64.451787326 | SIO2 | 85.141 | |
| 41 | −178.398872599 | 0.985111420 | AIR | 87.846 | |
| 42 | 0.000000000 | 60.000000000 | SIO2 | 83.174 | |
| 43 | 0.000000000 | 55.000000000 | SIO2 | 76.101 | |
| 44 | 0.000000000 | 15.000000000 | AIR | 77.022 | |
| 45 | 0.000000000 | 5.000000000 | SIO2 | 77.414 | |
| 46 | 0.000000000 | 4.998648774 | AIR | 77.498 | |
| 47 | 0.000000000 | 14.922600900 | AIR | 77.629 | |
| 48 | 0.000000000 | −19.921249600 | AIR | 80.516 | REFL |
| 49 | 0.000000000 | −5.000000000 | SIO2 | 84.786 | |
| 50 | 0.000000000 | −15.000000000 | AIR | 85.463 | |
| 51 | 0.000000000 | −55.000000000 | SIO2 | 88.683 | |
| 52 | 0.000000000 | 60.000000000 | SIO2 | 99.565 | REFL |
| 53 | 0.000000000 | 1.292050190 | AIR | 104.316 | |
| 54 | 160.238753201 | 58.643851457 | SIO2 | 115.110 | |
| 55 | 1539.574726680 | 204.762003530 | AIR | 110.827 | |
| 56 | −98.821667962 | 15.033218821 | SIO2 | 73.993 | |
| 57 | 281.947105707 | 39.811843611 | AIR | 90.480 | |
| 58 | 1032.758041210 | 45.208136748 | CAF2 | 112.549 | |
| 59 | −238.930889650 | 19.616124743 | AIR | 119.023 | |
| 60 | −1799.453558600 | 66.953749014 | SIO2 | 142.118 | |
| 61 | −207.938962450 | 1.009091703 | AIR | 146.289 | |
| 62 | 267.862557732 | 44.694260176 | SIO2 | 148.658 | |
| 63 | −3063.973189630 | 29.485430853 | AIR | 146.473 | |
| 64 | 0.000000000 | 4.994716106 | SIO2 | 143.411 | |
| 65 | 0.000000000 | 51.529572618 | AIR | 142.900 | |
| 66 | 0.000000000 | 0.000000000 | AIR | 134.600 | |
| 67 | 0.000000000 | −10.409005230 | AIR | 134.600 | |
| 68 | 496.198070169 | 39.380914612 | SIO2 | 134.157 | |
| 69 | −816.531445817 | 1.337633986 | AIR | 132.804 | |
| 70 | 405.762408860 | 30.931367239 | SIO2 | 122.739 | |
| 71 | −3906.368664640 | 1.770096841 | AIR | 119.504 | |
| 72 | 264.903018122 | 40.816514120 | CAF2 | 105.065 | |
| 73 | −1374.614175850 | 1.236658956 | AIR | 96.024 | |
| 74 | 58.335417466 | 65.931363764 | CAF2 | 55.136 | |
| 75 | 0.000000000 | 4.000000000 | H2O | 19.336 | |
| 76 | 0.000000000 | 0.000000000 | AIR | 13.238 | |

TABLE 1A
(Aspheric constants)
ASPHERIC CONSTANTS
SURFACE NO. 2

| | |
|---|---|
| K | 0.0000 |
| C1 | −2.40859863e−008 |
| C2 | −1.96102813e−012 |
| C3 | −2.42786852e−017 |
| C4 | 2.28748743e−020 |
| C5 | −3.13847872e−024 |
| C6 | 1.46201998e−028 |

SURFACE NO. 7

| | |
|---|---|
| K | 0.0000 |
| C1 | 9.78727900e−008 |
| | −4.55097170e−012 |
| | 2.23376826e−016 |
| | −1.33101685e−022 |
| C5 | −1.75057153e−025 |
| C6 | −4.49177367e−030 |

SURFACE NO. 14

| | |
|---|---|
| K | 0.0000 |
| C1 | −1.56447353e−007 |
| C2 | −1.37527588e−011 |
| C3 | −2.68588034e−015 |
| C4 | −4.43308713e−019 |
| C5 | 5.81449637e−026 |
| C6 | −3.37201644e−026 |

SURFACE NO. 19

| | |
|---|---|
| K | 0.0000 |
| C1 | −1.67973639e−008 |
| C2 | 9.21782642e−013 |
| C3 | −2.40287512e−017 |
| C4 | 4.99311535e−022 |
| C5 | −2.50632511e−027 |
| C6 | −4.26339932e−033 |

SURFACE NO. 25

| | |
|---|---|
| K | 0.0000 |
| C1 | 1.50986574e−008 |
| C2 | 1.61429407e−013 |
| C3 | 1.00711588e−017 |
| C4 | 1.01194446e−022 |
| C5 | −1.29785682e−027 |
| C6 | 3.47807152e−031 |

SURFACE NO. 29

| | |
|---|---|
| K | 0.0000 |
| C1 | −1.06775477e−007 |
| C2 | −4.68448729e−012 |
| C3 | −2.54979072e−016 |
| C4 | −8.64198359e−020 |
| C5 | 8.65154365e−024 |
| C6 | −1.26264346e−027 |

SURFACE NO. 37

| | |
|---|---|
| K | 0.0000 |
| C1 | −1.06775477e−007 |
| C2 | −4.68448729e−012 |
| C3 | −2.54979072e−016 |
| C4 | −8.64198359e−020 |
| C5 | 8.65154365e−024 |
| C6 | −1.26264346e−027 |

SURFACE NO. 41

| | |
|---|---|
| K | 0.0000 |
| C1 | 1.50986574e−008 |
| C2 | 1.61429407e−013 |
| C3 | 1.00711588e−017 |
| C4 | 1.01194446e−022 |
| C5 | −1.29785682e−027 |
| C6 | 3.47807152e−031 |

SURFACE NO. 55

| | |
|---|---|
| K | 0.0000 |
| C1 | 3.37680914e−008 |
| C2 | −1.74520526e−013 |
| C3 | −7.65940570e−018 |
| C4 | 8.16192807e−022 |
| C5 | −4.90450761e−026 |
| C6 | 1.36016400e−030 |

SURFACE NO. 56

| | |
|---|---|
| K | 0.0000 |
| C1 | −1.64836185e−008 |
| C2 | 1.63936415e−012 |
| C3 | 1.13311068e−016 |
| C4 | −2.21643833e−020 |
| C5 | 1.89992292e−026 |
| C6 | −1.30669454e−028 |

SURFACE NO. 58

| | |
|---|---|
| K | 0.0000 |
| C1 | −2.09930925e−008 |
| C2 | −7.99169263e−013 |
| C3 | −1.79935060e−018 |
| C4 | 6.94803196e−022 |
| C5 | −3.35575740e−026 |
| C6 | −3.69922630e−031 |

SURFACE NO. 63

| | |
|---|---|
| K | 0.0000 |
| C1 | 3.31517860e−008 |
| C2 | −1.35034732e−013 |
| C3 | 1.77244051e−018 |
| C4 | −5.94505518e−023 |
| C5 | −1.26459008e−027 |
| C6 | 4.18668155e−032 |

SURFACE NO. 73

| | |
|---|---|
| K | 0.0000 |
| C1 | 1.64882664e−008 |
| C2 | 3.43814940e−013 |
| C3 | −2.19233871e−017 |
| C4 | 1.16363297e−021 |
| C5 | −5.75706559e−028 |
| C6 | −5.12478609e−031 |

1-12. (canceled)

13. A catadioptric projection objective comprising:
a plurality of optical elements configured to image a pattern of a mask arranged in an object surface of the projection objective into an image field arranged in an image surface of the projection objective with a demagnifying imaging scale;
the optical elements forming a first imaging subsystem configured to image the pattern from the object surface into a first intermediate image, a second imaging subsystem configured to image the first intermediate image into a second intermediate image, the second imaging subsystem including a concave mirror near a pupil surface of the second imaging subsystem; and a third imaging subsystem configured to image the second intermediate image into the image plane;
the object plane and the image plane being oriented parallel to one another;
the projection objective including an image rotating device effecting an image rotation through 180°,
whereby the imaging scale has the same sign in two planes perpendicular to an optical axis and perpendicular to one another.

14. The projection objective as claimed in claim 13, wherein the image rotating device is an image rotating reflection device including multiple planar reflection surfaces situated at an angle with respect to one another to effect the image rotation through 180° by multiple reflection at the planar reflection surfaces.

15. The projection objective as claimed in claim 14, wherein the projection objective includes a deflection system for deflecting bundles of rays from one part of the projection objective into another part of the projection objective, the deflection system containing the image rotating reflection device.

16. The projection objective as claimed in claim 14, wherein the image rotating reflection device comprises a reflection prism.

17. The projection objective as claimed in claim 16, wherein the reflecting prism is configured as a roof prism.

18. The projection objective as claimed in claim 14, wherein the image rotating reflection device comprises an angular mirror.

19. The projection objective as claimed in claim 18, wherein the angular mirror contains two plane mirrors configured to adjust in position relative to one another.

20. The projection objective as claimed in claim 14, wherein the image rotating reflection device comprises a physical beam splitter having a planar beam splitter surface which forms a reflection surface of the image rotating reflection device.

21. The projection objective as claimed in claim 20, wherein the physical beam splitter comprises at least one polarization-selective beam splitter surface.

22. The projection objective as claimed in claim 13, wherein the projection objective comprises no more than a single concave mirror.

23. The projection objective as claimed in claim 22, wherein the projection objective includes a deflection system with a first reflecting surface deflecting bundles of rays from the object plane towards the concave mirror and a second reflecting surface deflecting bundles of rays from the concave mirror towards the image plane.

24. A catadioptric projection objective with an object plane and an image plane optically conjugate to the object plane, the object plane and the image plane being oriented parallel to one another; the projection objective comprising:
a first imaging subsystem, configured to form a first intermediate image from radiation coming from the object surface,
a second imaging subsystem, configured to form a second intermediate image from the first intermediate image, the second imaging subsystem comprising a concave mirror near a pupil of the second imaging subsystem, and
a third imaging subsystem, configured to image the second intermediate image onto the image plane,
wherein the projection objective has no image flip.

25. The projection objective as claimed in claim 24, wherein the projection objective comprises no more than a single concave mirror.

26. The projection objective as claimed in claim 25, wherein the projection objective includes a deflection system with a first planar reflecting surface deflecting bundles of rays from the object plane towards the concave mirror and a second planar reflecting surface deflecting bundles of rays from the concave mirror towards the image plane.

27. A catadioptric projection objective for imaging a pattern of a mask arranged in an object surface of the projection objective into an image field arranged in an image surface of the projection objective, with a demagnifying imaging scale; wherein
the object plane and the image plane are oriented parallel to one another;
a deflection system for deflecting bundles of rays from one part of the projection objective into another part of the projection objective is arranged between the object plane and the image plane; and
the deflection system contains an image rotating reflection device, which is designed to effect an image rotation through 180° by multiple reflection at planar reflection surfaces situated at an angle with respect to one another,
whereby the imaging scale has the same sign in two planes perpendicular to an optical axis and perpendicular to one another.
wherein the projection objective is formed from a first subsystem, which images a first intermediate image from the object field, a second subsystem, which forms a second intermediate image from the first intermediate image and comprises a concave mirror near a pupil, and a third subsystem, which images the second intermediate image onto the image plane.

28. The projection objective as claimed in claim 27, wherein the projection objective has no more than a single concave mirror.

29. The projection objective as claimed in claim 27, wherein the image rotating reflection device comprises a reflection prism.

30. The projection objective as claimed in claim 29, wherein the reflection prism is configured as a roof prism.

31. The projection objective as claimed in claim 27, wherein the image rotating reflection device comprises an angular mirror.
